(19) United States
(12) Patent Application Publication
(10) Pub. No.: US 2010/0199176 A1
(43) Pub. Date: Aug. 5, 2010

(54) ELECTRONIC DEVICE WITH TEXT PREDICTION FUNCTION AND METHOD

(76) Inventor: Fredrik A. Chronqvist, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/363,799

(22) Filed: Feb. 2, 2009

(51) Int. Cl. G06F 17/21

(52) U.S. Cl. 715/261

(57) ABSTRACT

An electronic device has a predictive text entry function. The electronic device may include a display for displaying a graphical text entry interface in the form of a mind map to a user and a control circuit that controls the displayed content of the mind map. The control circuit may be configured to receive a starting text input from the user and associate the starting text input with a center of the mind map. The control circuit also may be configured to analyze the starting text input to establish branches of additional text from which the user may select to add text to the starting text.

### TECHNICAL FIELD OF THE INVENTION

The technology of the present disclosure relates generally to text input and, more particularly, to an electronic device with a text prediction function that is based on a mind map user interface and corresponding method.

### BACKGROUND

Portable wireless electronic devices, such as mobile telephones, are becoming increasingly popular. Such devices are often used to compose and send messages, such as electronic mail messages and text messages. The conventional technique to enter text characters is to type the characters using a keypad or a touch screen.

To expedite text entry, predictive text techniques have been used. The conventional predictive text techniques observe the characters of a beginning of a word that the user has entered and provides a list of possible matching word and/or phrase choices. For example, if the user types in “ha” a menu of predictive word choices may be “happy,” “have a nice day,” etc. The user may continue to enter characters to narrow the possible matches or selected a desired prediction from the list. The selected prediction is then entered into the message under composition. This technique still relies heavily on conventional user inputs and interfaces.

### SUMMARY

To enhance predictive text entry, the present disclosure describes an electronic device with a text prediction function that is based on a mind map user interface and corresponding method. When a user enters one or more characters, such as for composing an electronic mail message or a text message, the entered character(s) are displayed at a center of a mind map. Stemming from the center are branches that corresponding to possible matching words or phrases that potentially complete the text that the user is attempting to enter. A user may select a matching branch for entry into the message or other text composition.

Traditionally, a mind map is a diagram used to represent words, ideas, tasks, or other items linked to and arranged radially around a central key word or idea. Mind maps are used to generate, visualize, structure, and classify ideas, and as an aid in study, organization, problem solving, decision making, and writing. The elements of a given mind map are arranged intuitively according to the importance of the concepts, and are classified into groupings, branches, or areas, with the goal of representing semantic or other connections between portions of information. By presenting ideas in a non-linear manner, mind maps encourage a brainstorming approach to planning and organizational tasks. Though the branches of a mind map represent hierarchical tree structures, their radial arrangement disrupts the prioritizing of concepts typically associated with hierarchies presented with more linear visual cues. The disclosed techniques of predictive text input build on the use of mind maps to facilitate text entry when composing a message or other body of text.

According to one aspect of the disclosure, an electronic device having a predictive text entry function includes a display for displaying a graphical text entry interface in the form of a mind map to a user; and a control circuit that controls the displayed content of the mind map, the control circuit configured to: receive a starting text input from the user and associate the starting text input with a center of the mind map; and analyze the starting text input to establish branches of additional text from which the user may select to add text to the starting text.

According to one embodiment of the electronic device, the control circuit is further configured to add a user selection of additional text from one of the branches to the text associated with the center of the mind map, and revise the branches of additional text based on the selection.

According to one embodiment of the electronic device, the control circuit is further configured to add the starting text in combination with a user selection of additional text from one of the branches to a message or body of text undergoing composition.

According to one embodiment of the electronic device, the branches of additional text are derived from a lexicon of commonly used words, word pairings, and phrases.

According to one embodiment of the electronic device, the lexicon is user independent.

According to one embodiment of the electronic device, the lexicon adapts over time to the include words, word pairings, and phrases that are commonly used by the user.

According to another aspect of the disclosure, a method of predictive text entry includes displaying a graphical text entry interface in the form of a mind map to a user; and controlling the displayed content of the mind map by receiving a starting text input from the user and associating the starting text input with a center of the mind map, and analyzing the starting text input to establish branches of additional text from which the user may select to add text to the starting text.

According to one embodiment, the method further includes adding a user selection of additional text from one of the branches to the text associated with the center of the mind map, and revising the branches of additional text based on the selection.

According to one embodiment, the method further includes adding the starting text in combination with a user selection of additional text from one of the branches to a message or body of text undergoing composition.

According to one embodiment of the method, the branches of additional text are derived from a lexicon of commonly used words, word pairings, and phrases.

According to one embodiment of the method, the lexicon is user independent.

According to one embodiment of the method, the lexicon adapts over time to the include words, word pairings, and phrases that are commonly used by the user.

According to another aspect of the disclosure, a computer readable medium storing a predictive text entry program includes executable instructions to generate a displayable graphical text entry interface in the form of a mind map; control the displayed content of the mind map by associating starting text input from a user with a center of the mind map and analyzing the starting text input to establish branches of additional text from which the user may select to add text to the starting text.

According to one embodiment of the computer readable medium, the program further contains executable instructions to add a user selection of additional text from one of the branches to the text associated with the center of the mind map, and revise the branches of additional text based on the selection.

According to one embodiment of the computer readable medium, the program further contains executable instructions to add the starting text in combination with a user selection of additional text from one of the branches to a message or body of text undergoing composition.

According to one embodiment of the computer readable medium, the branches of additional text are derived from a lexicon of commonly used words, word pairings, and phrases.

According to one embodiment of the computer readable medium, the lexicon is user independent.

According to one embodiment of the computer readable medium, the lexicon adapts over time to the include words, word pairings, and phrases that are commonly used by the user.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic view of a mobile telephone as an exemplary electronic device that includes a text prediction function;

FIG. 2 is a schematic block diagram of the mobile telephone of FIG. 1;

FIG. 3 is a schematic diagram of a communications system in which the mobile telephone of FIG. 1 may operate;

FIG. 4 is a flow chart representing an exemplary method of text prediction using the mobile telephone of FIG. 1; and

FIGS. 5 and 6 are schematic diagrams of a display of the mobile telephone while displaying a representative interactive mind map as a graphical user interface for the text prediction function.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a portable radio communications device, such as the illustrated mobile telephone. It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, a media player, a gaming device, a computer, a pager, a communicator, an electronic organizer, a personal digital assistant (PDA), a smartphone, a portable communication apparatus, etc.

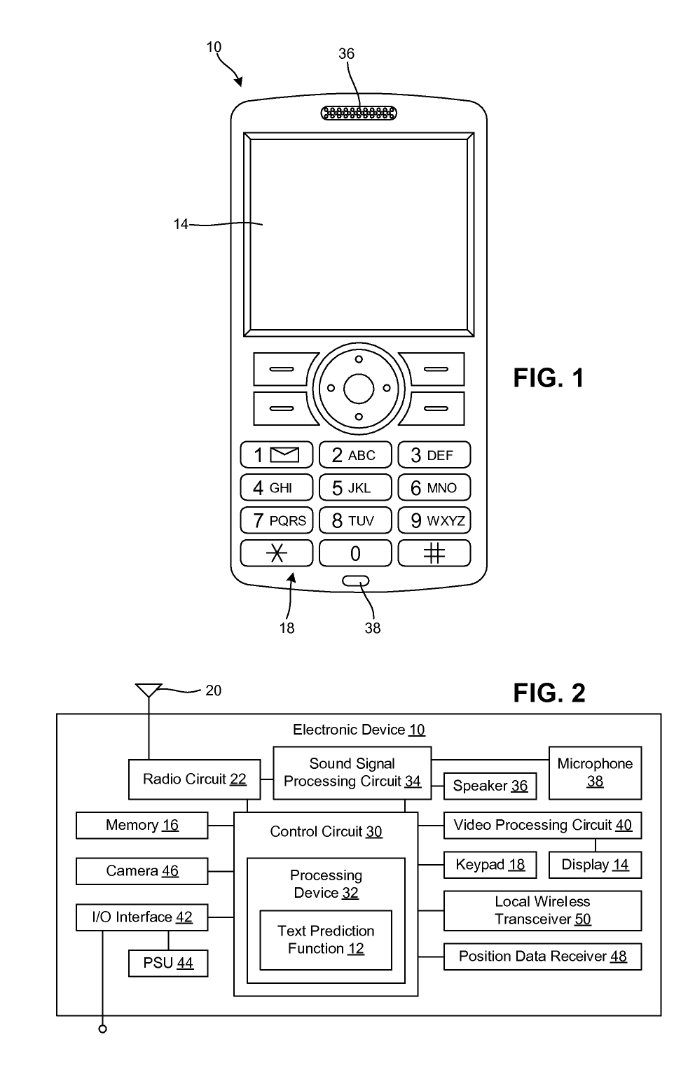

Referring initially to FIGS. 1 and 2, an electronic device 10 is shown. The electronic device 10 includes a text prediction function 12 that is configured to assist a user compose text, such as text for a message (e.g., an electronic mail message or a text message). Additional details and operation of the text prediction function 12 will be described in greater detail below. The text prediction function 12 may be embodied as executable instructions (e.g., code) that is resident in and executed by the electronic device 10. In one embodiment, the text prediction function 12 may be one or more programs that are stored on a computer or machine readable medium. The text prediction function 12 may be a stand-alone software application or form a part of a software application that carries out additional tasks related to the electronic device 10.

Through the following description, exemplary techniques for text prediction are described. Also, while the text prediction function 12 is implemented in software in accordance with an embodiment, such functionality could also be carried out via dedicated hardware or firmware, or some combination of hardware, firmware and/or software.

The electronic device 10 may include a display 14. The display 14 displays information to a user such as operating state, time, telephone numbers, contact information, various menus, etc., that enable the user to utilize the various features of the electronic device 10. The display 14 also may be used to visually display content received by the electronic device 10 and/or retrieved from a memory 16 (FIG. 2) of the electronic device 10. The display 14 may be used to present images, video and other graphics to the user, such as photographs, mobile television content, Internet pages, and video associated with games.

A keypad 18 provides for a variety of user input operations. For example, the keypad 18 may include alphanumeric keys for allowing entry of alphanumeric information (e.g., telephone numbers, phone lists, contact information, notes, text, etc.), special function keys (e.g., a call send and answer key, multimedia playback control keys, a camera shutter button, etc.), navigation and select keys or a pointing device, and so forth. Keys or key-like functionality also may be embodied as a touch screen associated with the display 14. Also, the display 14 and keypad 18 may be used in conjunction with one another to implement soft key functionality.

The electronic device 10 includes communications circuitry that enables the electronic device 10 to establish communications with another device. Communications may include calls, data transfers, and the like. Calls may take any suitable form such as, but not limited to, voice calls and video calls. The calls may be carried out over a cellular circuit-switched network or may be in the form of a voice over Internet Protocol (VoIP) call that is established over a packet-switched capability of a cellular network or over an alternative packet-switched network (e.g., a network compatible with IEEE 802.11, which is commonly referred to as WiFi, or a network compatible with IEEE 802.16, which is commonly referred to as WiMAX), for example. Data transfers may include, but are not limited to, receiving streaming content (e.g., streaming audio, streaming video, etc.), receiving data feeds (e.g., pushed data, podcasts, really simple syndication (RSS) data feeds), downloading and/or uploading data (e.g., image files, video files, audio files, ring tones, Internet content, etc.), receiving or sending messages (e.g., text messages, instant messages, electronic mail messages, multimedia messages), and so forth. This data may be processed by the electronic device 10, including storing the data in the memory 16, executing applications to allow user interaction with the data, displaying video and/or image content associated with the data, outputting audio sounds associated with the data, and so forth.

In the exemplary embodiment, the communications circuitry may include an antenna 20 coupled to a radio circuit 22. The radio circuit 22 includes a radio frequency transmitter and receiver for transmitting and receiving signals via the antenna 20.

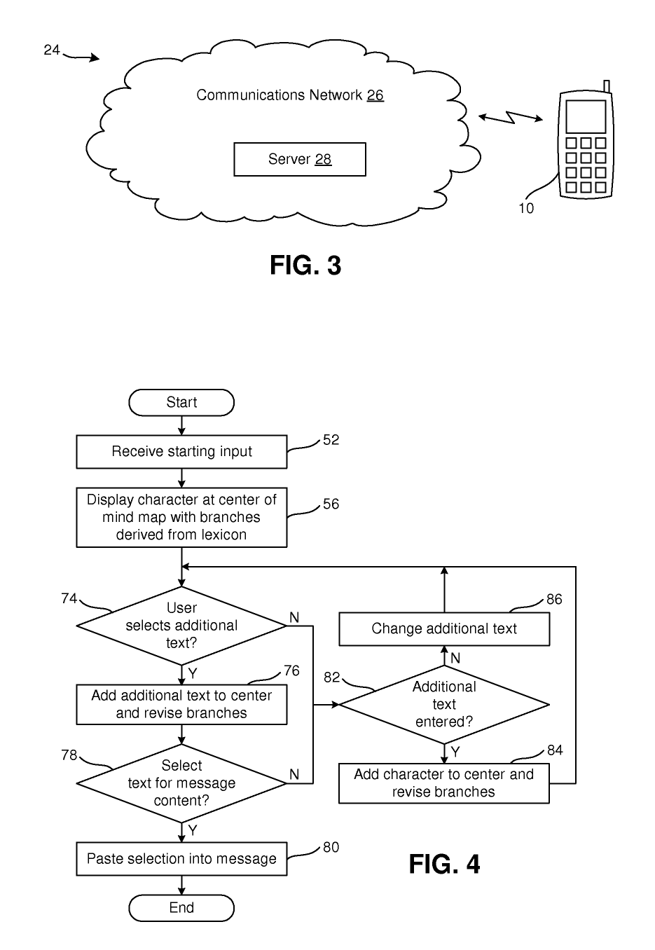

With additional reference to FIG. 3, the radio circuit 22 may be configured to operate in a mobile communications system 24. Radio circuit 22 types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMAX, digital video broadcasting-handheld (DVB-H), integrated services digital broadcasting (ISDB), digital multimedia broadcasting (DMB), China multimedia mobile broadcasting (CMMB), high speed packet access (HSPA), etc., as well as advanced versions of these standards or any other appropriate standard. It will be appreciated that the electronic device 10 may be capable of communicating using more than one standard. Therefore, the antenna 20 and the radio circuit 22 may represent one or more than one radio transceiver.

The system 24 may include a communications network 26 having a server 28 (or servers) for managing calls placed by and destined to the electronic device 10, transmitting data to and receiving data from the electronic device 10 and carrying out any other support functions. The server 28 communicates with the electronic device 10 via a transmission medium. The transmission medium may be any appropriate device or assembly, including, for example, a communications base station (e.g., a cellular service tower, or “cell” tower), a wireless access point, a satellite, etc. The network 26 may support the communications activity of multiple electronic devices 10 and other types of end user devices. As will be appreciated, the server 28 may be configured as a typical computer system used to carry out server functions and may include a processor configured to execute software containing logical instructions that embody the functions of the server 28 and a memory to store such software. In alternative arrangements, the electronic device 10 may wirelessly communicate directly with another electronic device 10 (e.g., another mobile telephone or a computer) and without an intervening network.

The electronic device 10 may include a primary control circuit 30 that is configured to carry out overall control of the functions and operations of the electronic device 10. The control circuit 30 may include a processing device 32, such as a central processing unit (CPU), microcontroller or microprocessor. The processing device 32 executes code stored in a memory (not shown) within the control circuit 30 and/or in a separate memory, such as the memory 16, in order to carry out operation of the electronic device 10. For instance, the processing device 32 may execute code that implements the text prediction function 12. The memory 16 may be, for example, one or more of a buffer, a flash memory, a hard drive, a removable media, a volatile memory, a non-volatile memory, a random access memory (RAM), or other suitable device. In a typical arrangement, the memory 16 may include a non-volatile memory for long term data storage and a volatile memory that functions as system memory for the control circuit 30. The memory 16 may exchange data with the control circuit 30 over a data bus. Accompanying control lines and an address bus between the memory 16 and the control circuit 30 also may be present.

The electronic device 10 further includes a sound signal processing circuit 34 for processing audio signals transmitted by and received from the radio circuit 22. Coupled to the sound processing circuit 34 are a speaker 36 and a microphone 38 that enable a user to listen and speak via the electronic device 10. The radio circuit 22 and sound processing circuit 34 are each coupled to the control circuit 30 so as to carry out overall operation. Audio data may be passed from the control circuit 30 to the sound signal processing circuit 34 for playback to the user. The audio data may include, for example, audio data from an audio file stored by the memory 16 and retrieved by the control circuit 30, or received audio data such as in the form of voice communications or streaming audio data from a mobile radio service. The sound processing circuit 34 may include any appropriate buffers, decoders, amplifiers and so forth.

The display 14 may be coupled to the control circuit 30 by a video processing circuit 40 that converts video data to a video signal used to drive the display 18. The video processing circuit 40 may include any appropriate buffers, decoders, video data processors and so forth. The video data may be generated by the control circuit 30, retrieved from a video file that is stored in the memory 16, derived from an incoming video data stream that is received by the radio circuit 22 or obtained by any other suitable method.

The electronic device 10 may further include one or more input/output (I/O) interface(s) 42. The I/O interface(s) 42 may be in the form of typical mobile telephone I/O interfaces and may include one or more electrical connectors. The I/O interfaces 42 may form one or more data ports for connecting the electronic device 10 to another device (e.g., a computer) or an accessory (e.g., a personal handsfree (PHF) device) via a cable. Further, operating power may be received over the I/O interface(s) 42 and power to charge a battery of a power supply unit (PSU) 44 within the electronic device 10 may be received over the I/O interface(s) 42. The PSU 44 may supply power to operate the electronic device 10 in the absence of an external power source.

The electronic device 10 also may include various other components. A camera 46 may be present for taking digital pictures and/or movies. Image and/or video files corresponding to the pictures and/or movies may be stored in the memory 16. A position data receiver 48, such as a global positioning system (GPS) receiver or the like, may be involved in determining the location of the electronic device 10. A local wireless interface 50, such as an infrared transceiver and/or an RF transceiver (e.g., a Bluetooth chipset) may be used to establish communication with a nearby device, such as an accessory (e.g., a PHF device), another mobile radio terminal, a computer or another device.

With additional reference to FIG. 4, illustrated are logical operations to implement an exemplary method of text prediction. The exemplary method may be carried out by executing an embodiment of the text prediction function 12, for example. Thus, the flow chart of FIG. 4 may be thought of as depicting steps of a method carried out by the electronic device 10. Although FIG. 4 shows a specific order of executing functional logic blocks, the order of executing the blocks may be changed relative to the order shown. Also, two or more blocks shown in succession may be executed concurrently or with partial concurrence. Certain blocks also may be omitted.

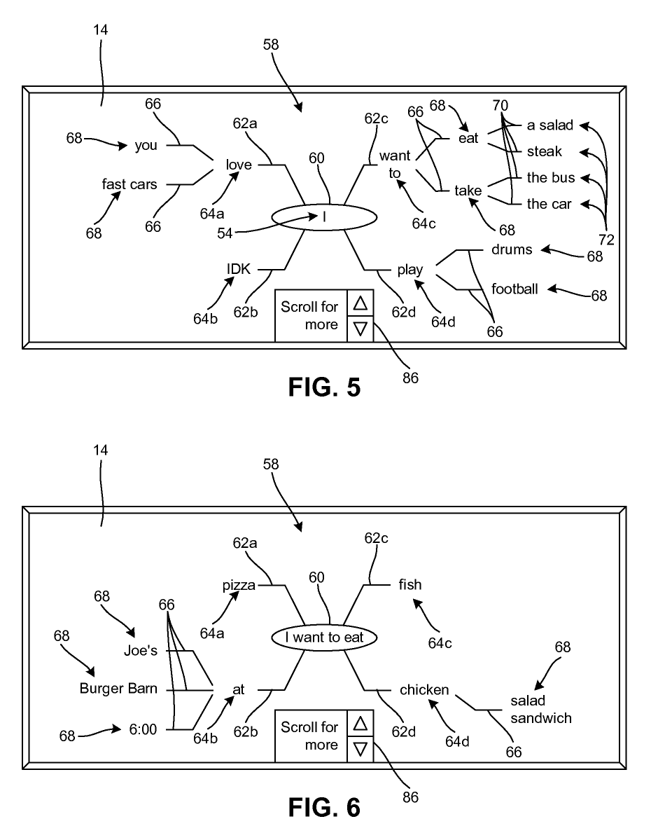

With additional reference to FIG. 5, the logical flow for the text prediction function 12 may begin in block 52 where a user enters starting text 54. The starting text 54 may be a character (e.g., a letter, a number or a symbol), a part of a word, a complete word, a complete word and a portion of a second word, a part of a phrase, or a complete phrase. The starting text 54 may be received by the control circuit 30 for processing by the text prediction function 12. The starting text 54 may be entered in any suitable manner including, for example, pressing one or more keys from the keypad 18, touching one or more appropriate locations of the touch screen display 14, or by speaking the starting text and using the electronic device 10 to convert the speech to text.

As indicated, the starting text 54 may include one or more characters, such as one or more letters, one or more numbers, one or more symbols or a combination of character types. For example, the starting text may correspond to the first character (e.g., letter) of a word or of a phrase that the user desires to enter. In the illustrated example, the starting text is the English letter “I”.

In block 56, and in response to input of the starting text 54, the display 14 may be controlled to display a mind map 58. It will be appreciated that the illustrated mind map 58 is representative of the operation of the text prediction function 12 and is not intended to limit the format or content of the mind map 58. The starting text 54 may be displayed in a center 60 of the mind map 58. It is noted that the center 60 corresponds to the logical center of the concept displayed by the mind map 58 and need not be physically centered on the display 14 and need not be the physical center of the displayed mind map 58.

Also in block 56, the text prediction function 12 will use the starting text 58 to construct branches 62 of the mind map 58. In the illustrated example, there are four branches 62a-62d stemming from the center 60, but there may be less than or more than four branches 62. Each branch 62 leads to a corresponding first level of additional text 64. The text prediction function 12 may analyze the starting text 54 to determine if the starting text 54 includes a complete word. For purposes of the text prediction function 12, a complete word need not be a complete dictionary-style word, but complete words may include acronyms and other character combinations that are commonly used in text entry for a particular meaning. As just a few examples, the characters “BFF” are commonly used by text message users to stand for “best friends forever,” the characters “BRB” are commonly used by text message users to stand for “be right back,” and the characters “IDK” are commonly used by text message users to stand for “I don't know.”

If the starting text 54 is not a complete word, then the additional text 64 may be additional characters that complete a word that is started by the one or more characters present in the center 60. If the starting text 54 is a complete word, then each additional text 64 may be a word or words that commonly follow the word in the center 60. As indicated, for purposes of the illustrated example, the starting text 54 is “I”. The letter “I” may be used as a complete word or as the first character of a word. Similarly, many two, three or more letter combinations may start a word or may be a complete word. In these situations, each additional text 64 element may be a word or words that start with the character(s) (e.g., the exemplary “I”), each additional text 64 element may be a word or words that follow a word made from the character(s), or some of the additional text 64 elements may be a word or words that start with the character(s) and some of the additional text 64 elements may be a word or words that follow the word made from the character(s). For instance, in the exemplary representation of FIG. 5, the additional text 64a is the word “love,” the additional text 64b is “IDK,” the additional text 64c is “want to,” and the additional text 64d is “play.” When interpreted with the text in the center 60, these exemplary additional text 64 elements respectively may be read “I love,” “I don't know,” “I want to,” and “I play.” It is noted that the displayed additional text 64 elements need not be in an alphabetical order. Rather, the content and/or associated concepts relating to words that semantically follow the starting text 54 drives the displayed branches and additional text.

The text prediction function 12 may make use of a lexicon or other database to narrow the number of possibilities for the first level of additional text 64, and for subsequent levels of additional text as described below. In the exemplary context of text messaging, the lexicon may be or may start as a user independent lexicon that contains includes common words, word pairings, and phrases, and their relative frequency of use in text messages for the various combinations. The lexicon may track user behavior to recognize words, word pairing, and phrases that the user commonly uses to either build a user-specific lexicon or, over time, adapt a user independent lexicon to the writing style of the user. In this manner, past text entry by the user may be used so that the text prediction function 12 learns the phrases commonly used by the user and semantics of the user to lead to more accurate predictions as to the text that the user is attempting to enter.

In one embodiment, the most frequently used word combinations may be presented in the mind map 58 to expedite the entry of text. Also, any existing text that forms the message or other body of text undergoing composition may be used to guide the displayed branches and additional text.

Sub-branches 66 flowing from the first level of additional text 64 may lead to a second level of additional text 68. Still additional sub-branches 70 may lead to a third level of additional text 72. Although three levels of text are illustrated, additional levels may form part of the mind map 58.

Following block 56, the logical flow may proceed to block 74. In block 74, a determination may be made as to whether the user has selected a branch of additional text to add to the starting text 54. Selection of additional text may be made by touching a corresponding spot on the display 14 or by using an input device, such as a pointing device. If a positive determination is made in block 74, the logical flow may proceed to block 76 where the selected text and any intervening levels of additional text are added to text in the center 60.

For example, with additional reference to FIG. 6, the illustrated representation of FIG. 5 has been revised for user selection of the text “eat” from the second level of additional text 68. The result is that the text in the center is revised to read “I want to eat.” Also, the branches and levels of additional text may be revised based on the user selection of additional text, as is also illustrated by example in FIG. 6. Since the option of “a salad” and the option of “steak” were not selected from the third level of addition text 72, these options need not be displayed in the revised mind map. As an example, the mind map 58 of FIG. 6 has alternative food choices for the new first level of additional text 64 and a branch 62b directed to time or place.

Next, in block 78, a determination may be made as to whether the user has selected text to become part of the content of the message or other body of text undergoing composition. For example, selection of text to add to the message or other body of text undergoing composition may be made by touching the display 14 over the center 60 (or other appropriate display area), using an input device, or pressing a selection key. If a positive determination is made in block 78, the selected text may be pasted or otherwise added to the message or other body of text undergoing composition in block 80.

Following a negative determination in either of blocks 74 or 78, the logical flow may proceed to block 82. In block 82, a determination may be made as to whether the user has entered any additional characters or text for addition to the end of the characters or text present in the center 60. It also may be possible for the user to edit the text in the center by adding a character(s) or a word(s) between existing characters or words. If a positive determination is made in block 82, the logical flow may proceed to block 84 where the text in the center 60 may be revised with the additional characters and the branches and additional text choices may be revised based on the added text. Following block 84, the logical flow may proceed back to block 74.

If a negative determination is made in block 82, a conclusion may be made that none of the displayed addition text is to the liking of the user. In that case, the logical flow may proceed to block 86 where the branches and additional text may be revised. The branches may be revised automatically (e.g., after a predetermined time elapses) or based on a user input. For example, scroll icons 86 may be displayed. Selection of a scroll icon may provide the user with a different arrangement of branches and additional text. Following block 86, the logical flow may proceed back to block 74.

The described techniques has advantage over conventional text prediction techniques in that multiple steps (or levels) of text choices may be offered to the user at the same time. For instance, from the example of FIG. 5, the user may be able to select “I want to” from a first level of choices along one branch 62c, or may be able to select “I want to take” from a second level of choices along the same branch 62c, or may select an entirely different text possibility to continue the center text by selecting from another of the branches 62 or by manually entering additional characters. Also, a relatively large amount of text may be entered by a single selection. For instance, from the example of FIG. 5, “I play football” may be selected by simply touching the word “football.”

It also will be appreciated, that mind maps are intuitive and instantly understandable by large numbers of people. Therefore, the disclosed techniques can make text entry a fast and instinctive process.

Although certain embodiments have been shown and described, it is understood that equivalents and modifications falling within the scope of the appended claims will occur to others who are skilled in the art upon the reading and understanding of this specification.

What is claimed is:

1. An electronic device having a predictive text entry function, comprising:
a display for displaying a graphical text entry interface in the form of a mind map to a user; and
a control circuit that controls the displayed content of the mind map, the control circuit configured to:
receive a starting text input from the user and associate the starting text input with a center of the mind map; and
analyze the starting text input to establish branches of additional text from which the user may select to add text to the starting text.

2. The electronic device of claim 1, wherein the control circuit is further configured to add a user selection of additional text from one of the branches to the text associated with the center of the mind map, and revise the branches of additional text based on the selection.

3. The electronic device of claim 1, wherein the control circuit is further configured to add the starting text in combination with a user selection of additional text from one of the branches to a message or body of text undergoing composition.

4. The electronic device of claim 1, wherein the branches of additional text are derived from a lexicon of commonly used words, word pairings, and phrases.

5. The electronic device of claim 4, wherein the lexicon is user independent.

6. The electronic device of claim 4, wherein the lexicon adapts over time to the include words, word pairings, and phrases that are commonly used by the user.

7. A method of predictive text entry, comprising:
displaying a graphical text entry interface in the form of a mind map to a user; and
controlling the displayed content of the mind map by receiving a starting text input from the user and associating the starting text input with a center of the mind map, and analyzing the starting text input to establish branches of additional text from which the user may select to add text to the starting text.

8. The method of claim 7, further comprising adding a user selection of additional text from one of the branches to the text associated with the center of the mind map, and revising the branches of additional text based on the selection.

9. The method of claim 7, further comprising adding the starting text in combination with a user selection of additional text from one of the branches to a message or body of text undergoing composition.

10. The method of claim 7, wherein the branches of additional text are derived from a lexicon of commonly used words, word pairings, and phrases.

11. The method of claim 10, wherein the lexicon is user independent.

12. The method of claim 10, wherein the lexicon adapts over time to the include words, word pairings, and phrases that are commonly used by the user.

13. A computer readable medium storing a predictive text entry program, comprising executable instructions to:
generate a displayable graphical text entry interface in the form of a mind map;
control the displayed content of the mind map by associating starting text input from a user with a center of the mind map and analyzing the starting text input to establish branches of additional text from which the user may select to add text to the starting text.

14. The computer readable medium of claim 13, wherein the program further contains executable instructions to add a user selection of additional text from one of the branches to the text associated with the center of the mind map, and revise the branches of additional text based on the selection.

15. The computer readable medium of claim 13, wherein the program further contains executable instructions to add the starting text in combination with a user selection of additional text from one of the branches to a message or body of text undergoing composition.

16. The computer readable medium of claim 13, wherein the branches of additional text are derived from a lexicon of commonly used words, word pairings, and phrases.

17. The computer readable medium of claim 16, wherein the lexicon is user independent.

18. The computer readable medium of claim 16, wherein the lexicon adapts over time to the include words, word pairings, and phrases that are commonly used by the user.
